(19) United States
(12) Patent Application Publication
(10) Pub. No.: US 2025/0170614 A1
(43) Pub. Date: May 29, 2025

(54) APPARATUS FOR DRY GRANULAR MIXTURES SEPARATION

(71) Applicant: Artem PEREKRESNYI, Rivne (UA)

(72) Inventor: Artem PEREKRESNYI, Rivne (UA)

(21) Appl. No.: 18/840,024

(22) PCT Filed: Dec. 1, 2022
(86) PCT No.: PCT/IB2022/061670

§ 371 Date: Aug. 20, 2024

(30) Foreign Application Priority Data
Feb. 21, 2022 (UA) A202200791

(51) Int. Cl. B07B 13/11; B07B 13/00

(52) U.S. Cl. CPC B07B 13/11; B07B 13/003

(57) ABSTRACT

An apparatus is proposed for separation of dry granular mixture into fractions with different content of particles of high density, where the spatial inhomogeneity of the concentration of dense particles in the volume of the mixture is created by rotating the dry granular mixture inside the channel curved along the spiral.

### FIELD OF THE INVENTION

The present invention relates to a devices for separating dry granular mixtures of particles of different densities into fractions differing in the content of dense particles.

### BACKGROUND OF THE INVENTION

In patents AU2002355613, NZ530680, US20040251181, CN1547514, EP1412103, WO/2003/011483, Kurt Liffman and Guy Parker Metcalfe III disclosed a method and apparatus for fractioning a granular mixture of particles of different densities by tumbling the granular mixture to produce continuous or discrete avalanches in the surface of the granular mixture. These avalanches move particles of higher density toward the center of the volume of the granular mixture, and conversely move particles of lower density radially outward from the center of the volume of the granular mixture. The separation of the granular mixture is performed inside a cylindrical apparatus equipped with a means for rotating the apparatus and for extracting fractions from certain parts of the mixture volume. A significant disadvantage of the previously disclosed apparatus is the need for additional means to remove particles of different densities from different regions of the volume of the mixture. In contrast to the aforementioned patents, the apparatus disclosed below needs no additional means to remove particles of different densities from different regions of the volume of the mixture.

### BRIEF DESCRIPTION OF THE DRAWINGS

FIG. 1 is a perspective view of the disclosed apparatus with a granular mixture inside.

FIG. 2 is a perspective view of the disclosed apparatus without a granular mixture inside.

FIG. 3 shows a frontal view of the disclosed apparatus and defines vertical longitudinal section 4-4.

FIG. 4 shows vertical longitudinal section 4-4 of the disclosed apparatus without a granular mixture inside and defines vertical transversal section 5-5.

FIG. 5 is an informal schematic representation of a segment of a vertical transversal section 5-5 of the disclosed apparatus with a granular mixture inside, and depicts the spatial distribution of particles of a granular mixture of different densities, which are obtained as a result of rotation of the mixture inside the disclosed apparatus.

FIG. 6 is an informal schematic representation of the lower part of the vertical longitudinal section 4-4 of the disclosed apparatus with the granular mixture inside, and depicts the longitudinal movements of the granular mixture parts inside the said apparatus.

### DISCLOSURE OF THE INVENTION

A preferred embodiment of the disclosed apparatus is selected from a set of possible embodiments for the purpose of simplicity to disclose the invention, to explain the processes occurring inside the apparatus, to demonstrate the technical result and to demonstrate the possibility of industrial application of the apparatus. This preferred embodiment does not preclude other embodiments corresponding to this disclosure.

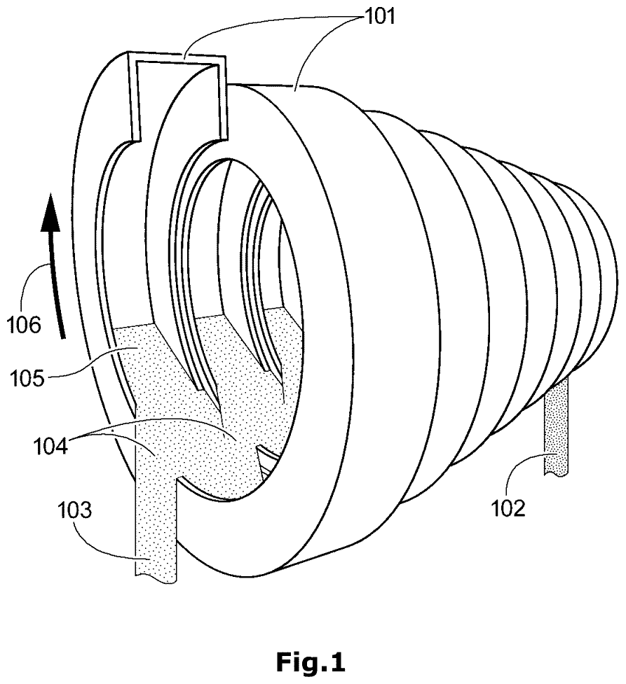

A preferred embodiment of the apparatus shown in FIG. 1 is a channel 101 of sufficient length, rectangular in cross-section and open at the top and ends. It is curved along a single-threaded left-handed helical spiral coiled around a regular cone, and the top side of the channel is directed towards the axis of the said cone. The dimensions of the cross-section of the channel decrease along the length of the channel in proportion to the decrease in the radius of curvature of the helical spiral along which the said channel is curved.

A preferred embodiment of the apparatus, shown in the perspective view of FIG. 1, can be described in a terms of a front part and a rear part. The front part of the apparatus is shown in the left part of FIG. 1, and the rear part of the apparatus is shown in the right part of FIG. 1. This definition of the front and rear parts will be referenced hereafter.

FIG. 1 also shows the granular mixture of paricles 105, which is comprised of different densities and similar sizes, which rotates inside the turns of the channel of the apparatus. The areas 104 denote where the excess mixture is poured out of the channel. The resulting fraction of the mixture enriched in dense particles is shown as 102. The resulting fraction of the mixture depleted of dense particles is shown as 103. Arrow 106 shows the direction of the rotation of the apparatus.

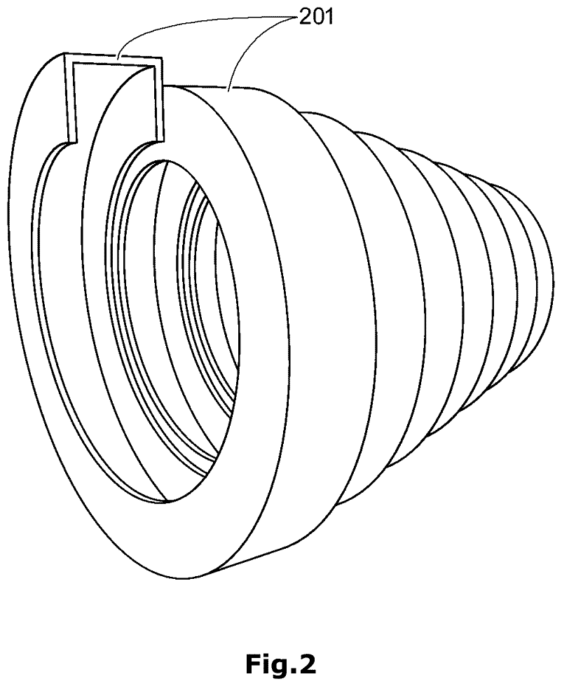

FIG. 2 shows a perspective view of the disclosed apparatus without the granular mixture inside.

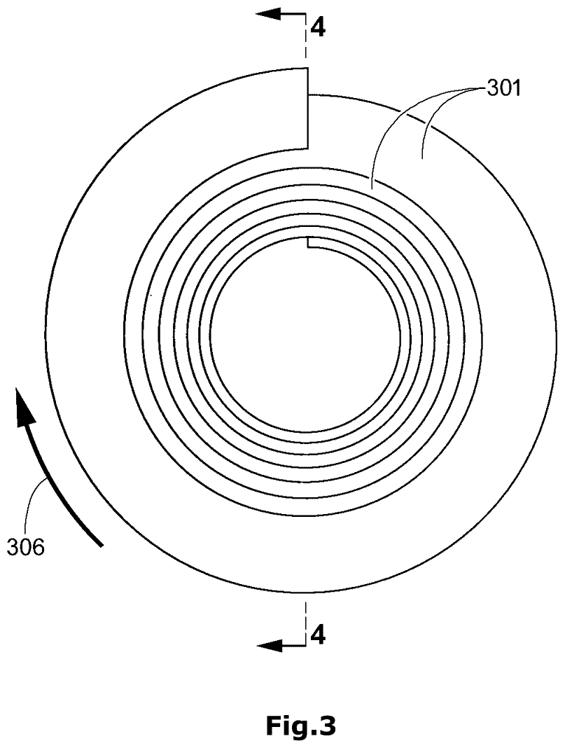

FIG. 3 shows the frontal projection of the disclosed apparatus, which shows the decrease in the radius of curvature of the channel 301 from the front part to the rear part of the apparatus. The direction of the working rotation of the apparatus 306 is also shown. Line 4-4 defines the plane of the vertical longitudinal section of the apparatus.

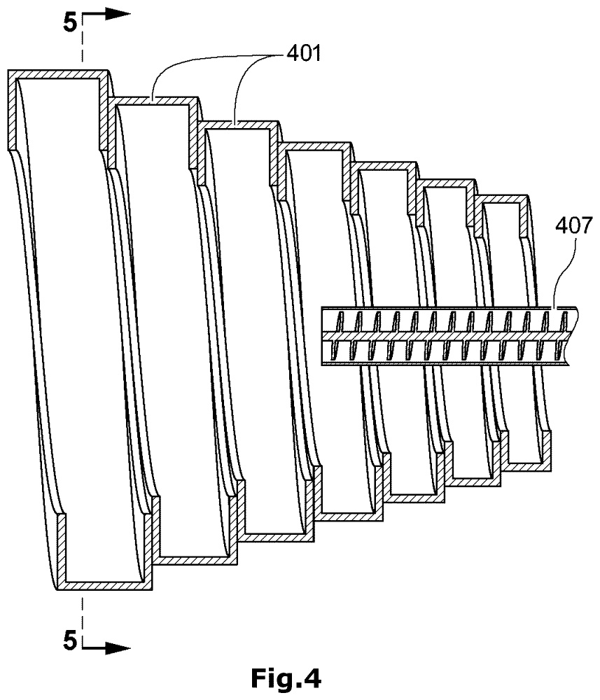

FIG. 4 shows a vertical longitudinal section 4-4 of the disclosed apparatus without the granular mixture inside and is oriented with the front part of the apparatus on the left and the rear part of the apparatus on the right. FIG. 4 also shows a decrease in the height of the walls and a decrease in the width of the bottom of the channel 401 along the length of the apparatus in proportion to the decrease in the radius of curvature of the channel. Line 5-5 defines the plane of the vertical transversal section of the apparatus. FIG. 4 also shows a screw conveyor 407, which was not shown in prior figures, as an example of a possible means for supplying a raw dry granular mixture inside the apparatus.

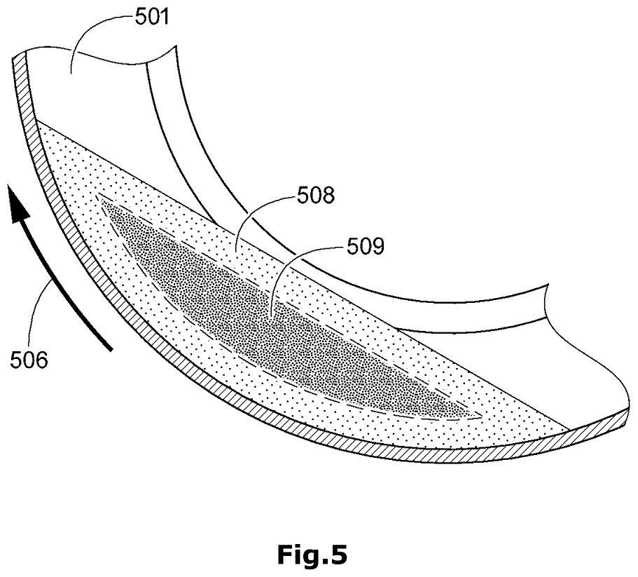

FIG. 5 shows the uneven spatial distribution of particles of varying density inside the volume of the granular mixture. The depicted distribution of particles results from the sedimentation of denser particles to the central area 509 of the mixture volume and the radial movement of less dense particles to the outer borders 508 of the mixture volume. This distribution is obtained by rotating the granular mixture Inside the turns of the channel 501 by rotating in the direction 506, according to the method known from the prior art.

When the disclosed apparatus rotates, the processes described above occur in each of the turns of the curved channel 101 forming the said apparatus. When rotating the curved channel 101, the granular mixture 105 inside it also rotates, as a result of which it makes a translational movement along the longitudinal axis of the apparatus from the front part to the rear part of the apparatus.

The curved channel 101 can hold a limited volume of granular mixture in each of its turns. The maximum volume is determined by the height of the walls of the curved channel, the width of its bottom, the radius of curvature of the said turn, and the speed of rotation of the said channel. The preferred embodiment of the apparatus is formed by a curved channel where the height of the walls, the width of the bottom and the radius of curvature decrease along the helical spiral from the front part to the rear part of the apparatus.

As a result, the volume of mixture that can be held by the curved channel of said apparatus gradually decreases along the direction of movement of the mixture within the channel, from the front part to the rear part of the apparatus. When moving the mixture from the front part to the rear of the apparatus, excess mixture occurs, which the segments of the said channel cannot hold. Also, excess mixture can be formed by feeding of the raw mixture inside the apparatus with the rate higher than the rate fraction 102 is produced.

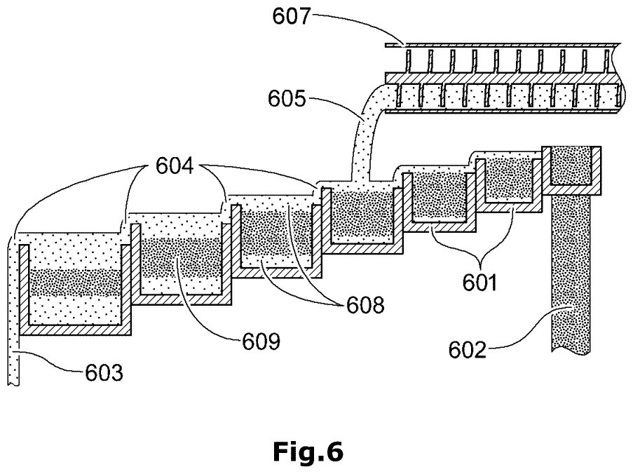

FIG. 6 schematically shows the lower part of the section 4-4 of the apparatus with the front part of the apparatus on the left and the rear part on the right. This cross-section shows the adjacent turns of the curved channel 601 with the mixture 605 inside, which is fed into the apparatus by means of the screw conveyor 607. Also shown is a decrease in the height of the walls, the width of the bottom, and the radius of curvature of the channel 601 from the front to the rear of the apparatus.

The wall of the channel 601 that is closer to the front side of the apparatus is hereinafter referred to as the front wall of the channel, and the wall of the channel 601 that is closer to the rear side of the apparatus is hereinafter referred to as the rear wall of the channel.

The upper edge of the front wall of the channel 601 is located higher than the upper edge of the rear wall of the previous turn. Therefore the above-mentioned excess of granular mixture in any particular turn of the channel can be poured only into the previous turn, closer to the front part of the apparatus, without the use of additional means. Also, the difference in height between the walls of adjacent turns of the channel can be achieved by tilting the axis of the apparatus to the horizon. The excess of the mixture pouring out into the previous turns of the channel of the apparatus is shown as 604.

An excess granular mixture 604 represent the outer part of the volumes 608 of the mixture in the channel which are depleted of dense particles and are poured out into the previous turns of the channel of the apparatus. This pouring action creates a flow of a low-density particles from the rear part to the front part of the apparatus. At the same time, the inner parts 609 of the mixture volumes are enriched in dense particles which are moved from the front part to the rear part of the apparatus as the apparatus rotates.

The excess mixture from the first turn of the channel, closest to the front of the apparatus, poures out of the apparatus and forms the resulting fraction 603 of the mixture, which is depleted of dense particles. The central part 609 of the mixture, which is moved to the rear of the apparatus, poures out from the last turn of the channel at the rear part of the apparatus and forms the resulting fraction 602 of the mixture which is enriched in dense particles.

As described above, the initial mixture is separated into fraction 603, depleted in dense particles, and fraction 602, enriched in dense particles, without the use of any means for extracting particles from certain areas of the volume of the granular mixture. This is a technical result of the application of the disclosed apparatus and proves the possibility of industrial application of the said apparatus for separating dry granular mixtures into fractions differing in the content of dense particles.

### BEST MODE FOR CARRYING OUT THE INVENTION

Other embodiments of the disclosed apparatus can be formed by combinations of channel segments of arbitrary cross-sectional shapes and proportions, curved along flat and helical spirals, single-threaded and multi-threaded, left-handed and right-handed, coiled around cylinders, prisms, cones and pyramids, regular and irregular. An exact geometry of the apparatus and the number of channel turns may be determined by practical feasibility of its manufacturing, the specific mixture of particles being separated, and other heuristics derives from testing for a particular application.

The adjacent walls of adjacent turns of the channel can be combined into the single common wall for feasibility of manufacturing.

The channel can be equipped with additional elements that prevent unwanted sliding of the mixture inside the channel, including, but not limited to, notches, protrusions, ribs, fins, lags etc.

The raw granular mixture can be sieved to the certain particle size range before feeding for better separation quality.

Multiple disclosed apparatuses can be combined in a sequence for better separation quality, in parallel for better separation performance, or both for better quality and performance.

The means for rotating and tilting the disclosed apparatus, the means for feeding the raw mixture, and the means for collecting the resulting fractions of the mixture are determined by the practical considerations of the manufacturing, operation and application of the said apparatus.

1. (canceled)

2. An apparatus for separating dry granular mixture of particles of different densities into fractions differing in content of high-density particles,
wherein the apparatus is configured to use a method of spatial separation in a volume of a granular mixture of particles of different densities by rotating the granular mixture to produce continuous or discrete avalanches in a surface of the granular mixture to move particles of higher density towards a center of the granular mixture and particles of lower density radially outward from the center of the granular mixture, and
wherein the apparatus comprises a channel curved along a spiral in which the said granular mixture rotates.
